(19) United States
(12) Patent Application Publication
(10) Pub. No.: US 2005/0058426 A1
(43) Pub. Date: Mar. 17, 2005

(54) Apparatus, system and method of authoring digitized audio/video recordings

(75) Inventors: Jerry Walter Malcolm, Austin, TX (US); Cristi Nesbitt Ullmann, Austin, TX (US); Lorin Evan Ullmann, Austin, TX (US)

Correspondence Address: Mr. Volel Emile, P.O. Box 202170, Austin, TX, 78720-2170, US

(73) Assignee: International Business Machines Corporation, Armonk, NY (US)

(21) Appl. No.: 10/660,292

(22) Filed: Sep. 11, 2003

(51) Int. Cl. H04N 9/79; H04N 5/76

(52) U.S. Cl. 386/35; 386/5; 386/4; 386/121; 386/40

(57) ABSTRACT

A system and method of authoring digitized audio/video recordings are provided. The system and method include previewing a digitized audio/video recording to identify scenes to be included in at least one version of the recording. A scene is a group of contiguous video frames. The scenes are associated with a title such that when the title is selected the version of the audio/video recording can be played back.

### BACKGROUND OF THE INVENTION

1. Technical Field

The present invention is directed generally to digital audio/video data. More specifically, the present invention is directed to an apparatus, system and method of authoring digital audio/video data recordings.

2. Description of Related Art

Typically, a three-minute footage of a digitized audio/video recording consumes about 1 gigabyte of storage space. Thus, it is not until the recent explosion of high capacity storage systems that producers are able to record and store motion pictures (including home movies) in a digitized format. A producer, in this case, is a person who records and/or edits digitized audio/video recordings. Hence, a producer may be a Hollywood studio producer, a professional wedding/event videographer or a person who records a home movie.

A producer who is recording and/or editing a digitized audio/video recording may desire to author the recording to enable parts of the recording to be played back based on particular selected titles. To author a recording is to provide one or more titles that an end-user may use to play the recording and to combine and link the titles to video, audio, and still image data. This then may provide an interactive menu to an end-user. An end-user is a person who views an edited/authored video recording.

Thus, what is needed is an apparatus, system and method of authoring a digitized audio/video recording enabling an end-user to selectively play back different parts of the recording.

### SUMMARY OF THE INVENTION

The present invention provides a system and method of authoring digitized audio/video recordings. The system and method include previewing a digitized audio/video recording to identify scenes to be included in at least one version of the recording. A scene is a group of contiguous video frames. The scenes are associated with a title such that when the title is selected the version of the audio/video recording can be played back.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a block diagram of a representative DVD mastering system in accordance with the invention.

FIG. 2 is a graphical user interface (GUI) in which a user may indicate whether a sub-menu title is to be used.

FIG. 3 is a GUI in which a sub-menu title may be entered.

FIG. 4 is a GUI in which a user may confirm whether another sub-menu tile is to be used.

FIG. 5 is a GUI in which a user may indicate BEGIN frame and END frame of a scene.

FIG. 6 depicts an extended attribute file used by the present invention.

FIG. 7 is a flow chart of a process that may be used to implement the invention.

FIG. 8 is an exemplary block diagram of a computer system according to the present invention.

### DETAILED DESCRIPTION OF THE PREFERRED EMBODIMENT

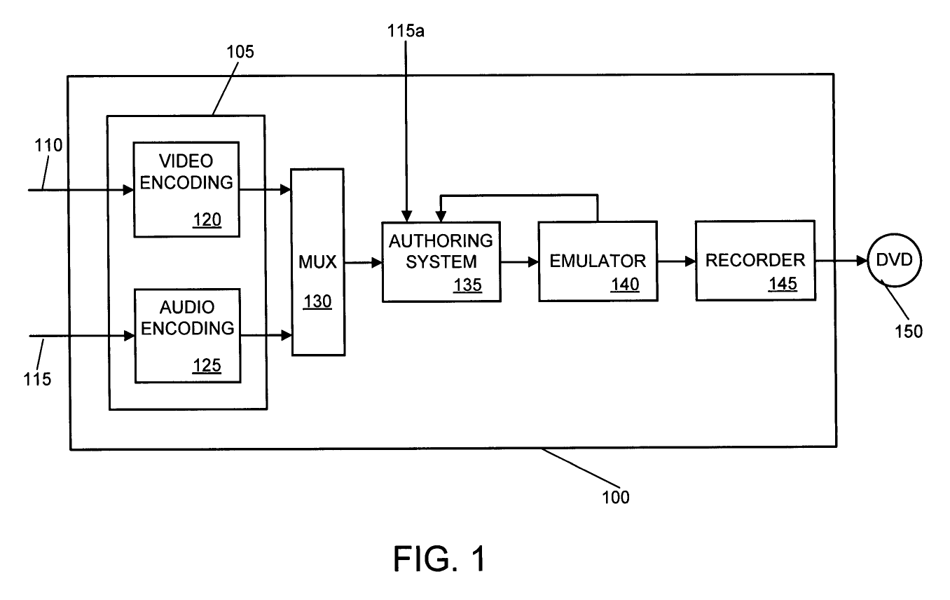

To author digital audio/video data, an audio/video mastering system is used. FIG. 1 is a block diagram of a representative audio/video mastering system 100 in accordance with the invention. The audio/video mastering system 100 has an encoder 105, a multiplexer (MUX) 130, an authoring system 135, an emulator 140 and a recorder 145. The encoder 105 may be used to convert an analog audio/video recording into a digitized format. Thus, the encoder may be a Moving Picture Experts Group 1 (MPEG-1) encoder, MPEG-2 encoder or any other encoding system that may be used to encode multimedia files. The encoder 105 has two inputs (inputs 110 and 115). Input 110 is used to capture analog video recordings while input 115 is used to capture analog audio recordings. If, however, the audio/video recording is already digitized, input 115a may be used.

In this particular example, the encoder is an MPEG-2 encoder. A modern MPEG-2 encoder may compress and encode both video and audio portions of a recording. The encoder may produce either a single file which contains both video and audio data or individual audio and video files. These individual files may be referred to as video or audio elementary streams. The MPEG-2 video elementary stream may have a filename extension of .MPV. The audio elementary stream filename extension, on the other hand, will correspond to the type of compression used to produce it (e.g., .PCM for Pulse Code Modulation, .AC3 for Dolby Digital, .M2A for MPEG-2 Audio, or .MPA for MPEG-1 or Layer-2 Audio).

In the present embodiment, two encoded elementary streams are produced and thus MUX 130 is used to combine the two streams into one file. This is required before authoring can occur. As alluded to above, authoring refers to the process of designing, creating, collecting, formatting data as well as creating control and navigational data.

As will be explained later, authoring system 135 allows a menu containing one or a list of titles to be used. Each title may be associated with a different version of the digitized recording. Initially, however, one title may be associated with the entire digitized recording. For example, if the analog recording was of a football game, a title such as “Team A vs. Team B Football Game” may be associated with the whole digitized recording.

After the initial authoring process, the resulting digitized data may be previewed using emulator 140. The emulator 140 emulates a multimedia player and thus will have all controls (i.e., play, fast forward, rewind, pause etc.) ordinarily included in a multimedia player. When previewing the digitized recording, a producer may choose to further create more control and navigational data in order to provide the different versions of the recording. For example, while the producer is previewing the recording, the producer may create a sub-menu title for offensive plays and another for defensive plays of one of the two teams. Thus, if the menu title for the Football game is selected, the entire game may be played back. If, however, the sub-menu title for the offensive plays is selected, then only the offensive plays of the particular team may be played back. Likewise, if the sub-menu title for the defensive plays is selected then only the defensive plays of the team may be played back. In cases where recordings that have materials unsuitable for children are being previewed, the producer may create control and navigational data for a censored version in addition to control and navigational data for an uncensored version.

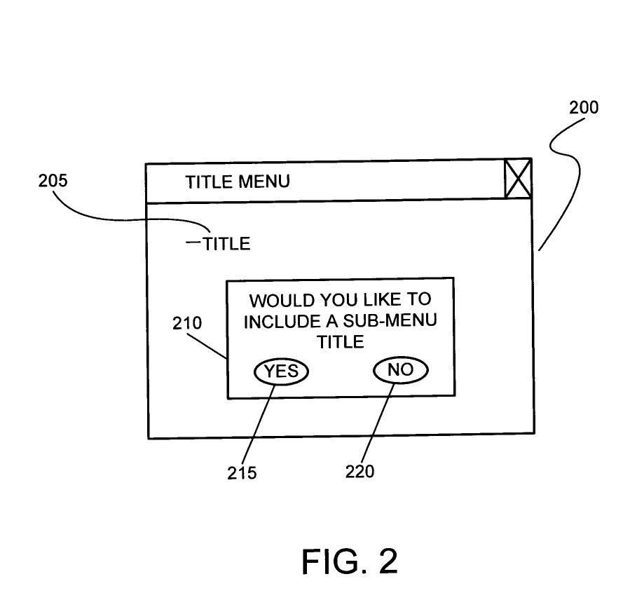

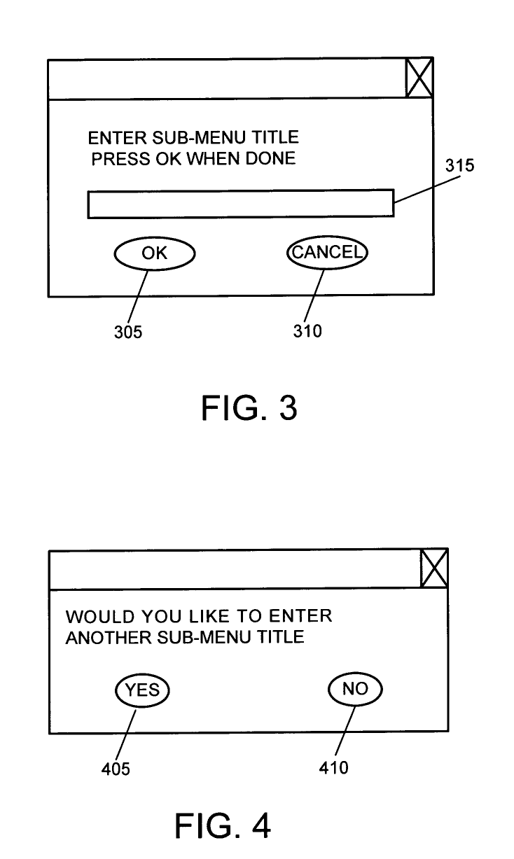

At the onset of the preview, FIG. 2 may pop open. Alternatively, FIG. 3 may pop open anytime two keys (e.g., CONTROL and Fl) of a keyboard are depressed simultaneously while a recording is being previewed. Having windows popped open is well known in the field and thus will not be explained. In any case, FIG. 2 is a graphical user interface (GUI) 200 that may be used by the invention. The GUI 200 has a MENU TITLE 205 and a box 210. The MENU TITLE 205 is the actual title of the recording (i.e., Team A vs. Team B Football Game). As mentioned above, this title will have been created during the initial authoring process.

The box 210 is used to prompt the user as to whether there should be sub-menu titles associated with the recording. If the user selects NO button 220, FIG. 2 may close and the previewed data may be transferred to a buffer (not shown) where it may be later stored in a storage system (e.g., hard drive, compact disk (CD), digital versatile disk (DVD) etc.) by recorder 145. In this particular example, the recording may be stored on a DVD 150 (see FIG. 1). If the user selects YES button 215, FIG. 2 may close and FIG. 3 may pop open.

In FIG. 3, the user is given an opportunity to enter the title of the sub-menu in title box 315. To continue with the Football game example above, the user may enter “Team A Offensive Plays” as a sub-menu title in title box 315. If the user decides against using a sub-menu title with the recording, the user may select CANCEL button 310; otherwise, the user may select OK button 305. Note that FIG. 3 will close when either OK button 305 or CANCEL button 310 is selected.

Once OK button 305 is selected, another GUI (FIG. 4) may pop open prompting the user to indicate whether another sub-menu title is to be used with the recording. If the user selects YES button 405, FIG. 4 may close and FIG. 3 may pop open again prompting the user to enter the title of the new sub-menu in title box 315. In that case, the user may enter “Team A Defensive Plays” in the title box 315 and press OK button 305. As stated above, upon selecting OK button 305, FIG. 4 may pop open (again) and when the user selects YES button 405 FIG. 3 may again pop open. This cycle may continue until the user selects NO button 410 in FIG. 4 or CANCEL button 310 in FIG. 3. Of course, if the user ever selects OK button 305 without first entering a title in the title box 315, an error message may be generated.

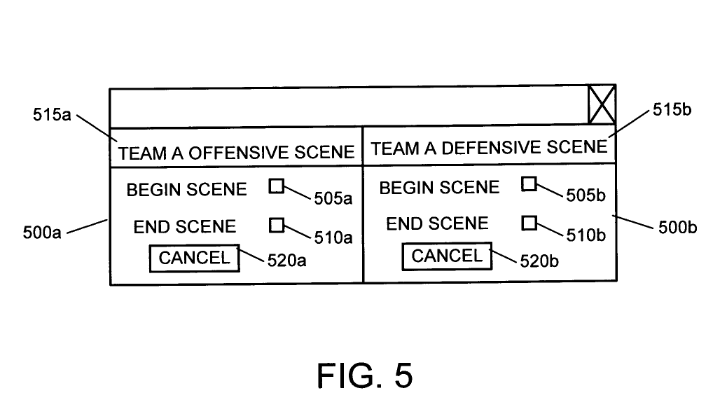

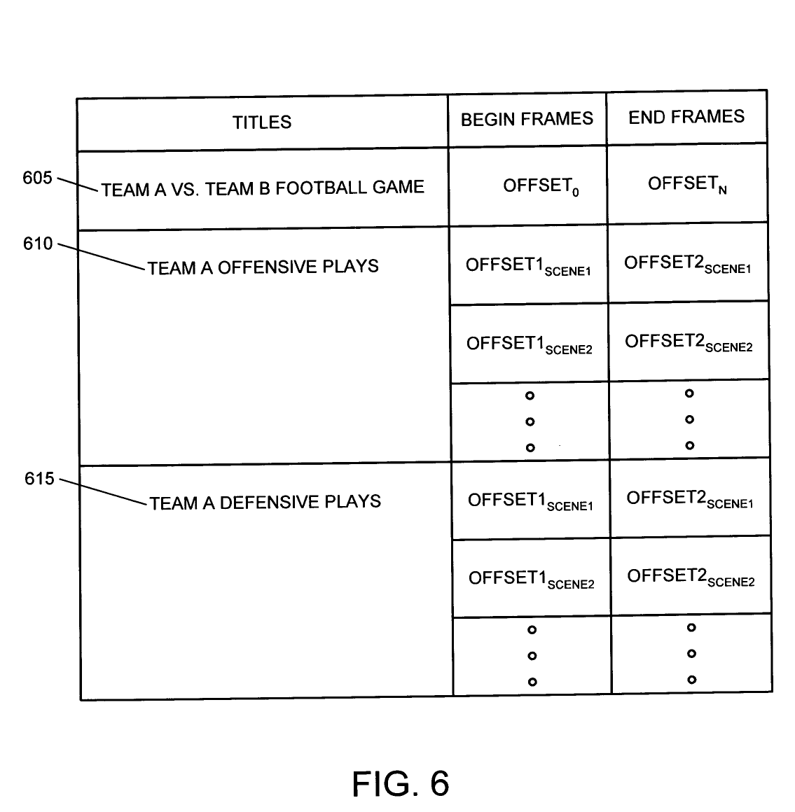

When CANCEL button 310 is selected and if at least one title had previously been entered into title box 315 or when the NO button 410 is selected, FIG. 5 may pop open. FIG. 5 may remain displayed in an unobtrusive area of the screen until the preview is terminated. FIG. 5 may contain as many sub-windows as there are sub-menu titles. In this example, two sub-menu titles were entered and thus two sub-windows, sub-windows 500a and 500b, are shown in the figure. Note that in order not to obfuscate the disclosure of the invention, FIG. 5 will be explained using generic reference numerals 505, 510, 515 and 520 rather than reference numerals 505a, 510a, 515a and 520a or 505b, 510b, 515b and 520b. However, it should be understood that the explanation applies equally to both sub-windows 500a and 500b.

The producer may preview the digital recording to identify different scenes that are to be associated with the sub-menu titles. A scene, in this case, is a group of contiguous video frames. Each scene is identified by a BEGIN frame and an END frame. As will be explained later, each BEGIN frame and each END frame are identified by an address offset. Alternatively, the BEGIN and END frames may be represented as a time offset into the file. Further, scenes may overlap. That is, any number of frames that are part of a scene may be associated with more than one sub-menu title.

To commence the preview, the producer may press the play button in the emulator 145. While the producer previews the digitized recording if the producer identifies a point where a scene that is to be associated with a sub-menu title 515 is to begin, the producer may rewind or fast forward to the first frame of the scene, freeze the frame using the pause button and put a check mark in begin scene box 505 associated with the particular sub-menu title. When a check mark is in the begin scene box 505, the box may be grayed out to indicate that it may not be chosen again until after a check mark has been entered into end scene box 510. Then, the producer may resume previewing the recording. When a point where the scene is to end is reached, the producer may again fast forward or rewind to the last frame of the scene, freeze the frame and enter a check mark in the end scene box 510. All the frames that are between a pair of BEGIN frame and END frame will be played in succession when the sub-menu title 515 is selected by an end-user.

As in the case of the check mark in the begin scene box 505, if a check mark is entered into end scene 510, it will be grayed out. At that point, the check mark in the begin scene box 505 will be deleted and the box 505 will no longer be grayed out. This then may indicate to the producer to continue previewing the recording for the next scene that is to be associated with the sub-menu title. These two boxes will alternately be grayed out until the end of the preview. Note that if an END scene was not identified before the end of the preview, the last frame in the recording may automatically be used as the END scene. Further, if the producer mistakenly identifies a frame as a BEGIN scene or END scene by putting a check mark in the begin scene box 505 or end scene 510, respectively, the producer may undo the identification by selecting CANCEL button 520.

Note that the identification of START and END frames may be implemented using other known graphical input techniques. For example, buttons may be used as an alternative to the checkboxes. Mouse clicks may be used along with thumbnail views of the video frames to specify the scene boundaries.

When the producer identifies a BEGIN frame and resumes previewing the recording, the sub-menu title and the location of the frame (i.e., its address offset) in the file is sent to a buffer (not shown). An offset refers to a value added to a base address to produce a second address. For example, if B represents address 100, then the expression, B+5 signifies address 105. The 5 in the expression is the offset. Specifying addresses using offsets is called relative addressing because the resulting address is relative to some other point (i.e., the base address). In this particular example, the base address is the address of the first piece of data in the digital audio/video file.

When the END frame of the scene is identified its offset is also sent to the buffer. The data in the buffer (i.e., sub-menu title, BEGIN frame and END frame offsets) will be sent to the authoring system 135. If, however, CANCEL button 520 is asserted before an END frame is identified, the data in the buffer will be invalidated and thus will not be transferred to the authoring system 135.

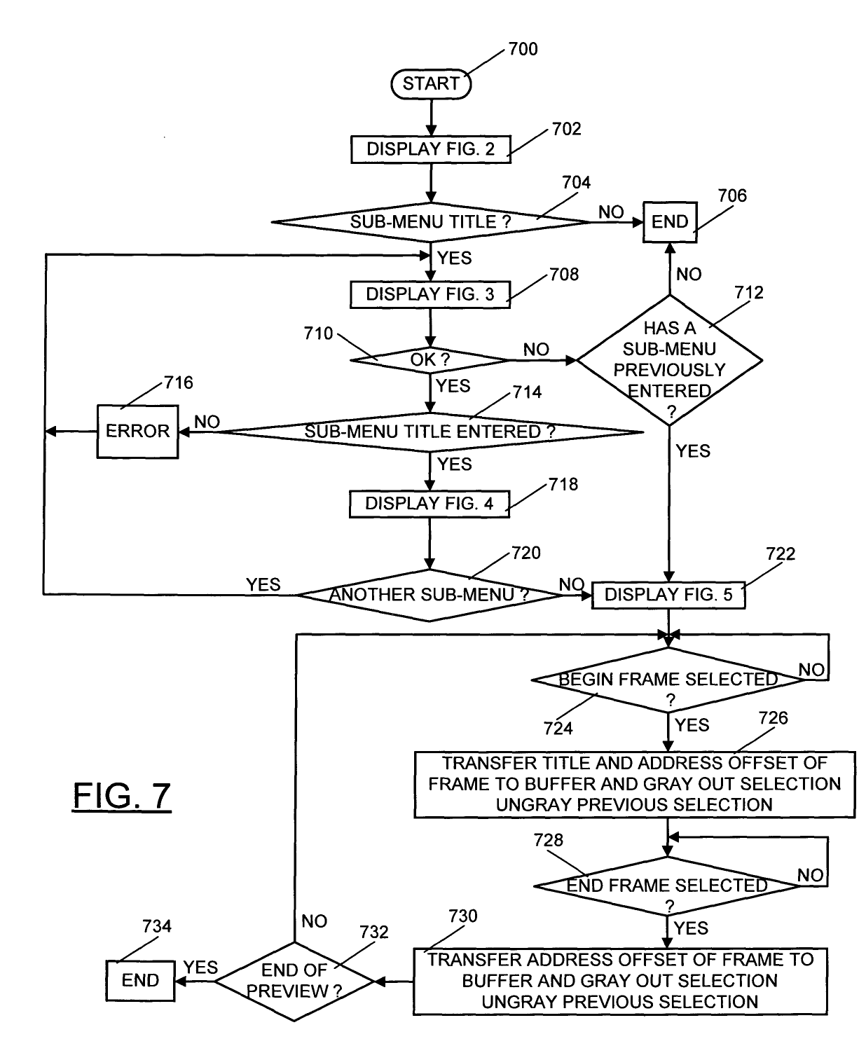

Returning to FIG. 1, when an audio/video file is being authored using authoring system 135, an extended attribute (EA) file is constructed. The EA file provides the navigational data for the recording. FIG. 6 depicts an EA file. All the titles (i.e., title 605 and sub-menu titles 610 and 615) used to identify the different parts of the recording are listed in the EA file. Associated with each title are offsets of BEGIN and END frames of scenes that are to be played back when the title is selected by an end-user.

Title 605 (i.e., Team A vs. Team B Football game) is the overall title of the recording. Consequently, it only has one associated scene. The BEGIN frame of the scene is at offset₀ and the END frame at offset_{N}, where N is equal to the length of the recording. Sub-menu titles 610 and 615, on the other hand, may have as many scenes as the producer identified during the preview. Each BEGIN frame of a scene is at a particular offset (e.g., offset1_{scene1}, offset1_{scene2}, etc). Likewise, each END frame of a scene is at another offset (e.g., offset2_{scene1}, offset2_{scene2}, etc).

When an end-user desires to play the recording, the EA file is first consulted. All the titles (e.g., title 105 and sub-menu titles 110 and 115) in the EA file are read from the EA file and presented to the end-user as options. When the end-user selects one of the titles, the recording will start to play by displaying the BEGIN frame of the first scene (i.e., scene₁) that is associated with the selected title. The recording will stop playing when the END frame of the last scene associated with the title is displayed. Note that the scenes will be played in the order they were identified.

After the recording has been authored to include the sub-menu titles etc., it may be previewed again. In this case, the producer will have more than one title to choose from in the on-screen menu (i.e., the title and the sub-menu titles). The producer may select each one of the titles to preview. In addition, the producer may further author the recording. Once, the producer is satisfied with the recording, the producer may have the recorder 145 record the data in a storage system (e.g., on DVD 155).

FIG. 7 is a flow chart of a process that may be used by the invention. The process starts by displaying FIG. 2 whenever a preview begins or when the CONTROL key and the F1 key on the keyboard are depressed simultaneously (steps 700 and 702). Then a check is made to determine whether a sub-menu title is to be incorporated in the recording. If a sub-menu title is not to be incorporated into the recording, the process ends (steps 704 and 706). If, however, a sub-menu title is to be incorporated, FIG. 3 is displayed (steps 704 and 708). If OK cancel button 310 is selected, a check is made to determine whether a sub-menu title has previously been entered. If not, the process ends (steps 710, 712 and 706). If a sub-menu title has previously been entered, FIG. 5 will be displayed (steps 710, 712 and 722).

If OK button in FIG. 3 is selected, a check will be made to determine whether a sub-menu title is entered. If not, an error will be generated and FIG. 3 will be displayed again after a few seconds (steps 710, 714, 716 and 708). If a sub-menu title was entered, FIG. 4 will then be displayed (steps 710, 714 and 718). A check will then be made to determine whether another sub-menu title is to be incorporated into the recording. If so, the process returns to step 708 (steps 720 and 708). If not, FIG. 5 is displayed (steps 718 and 720).

When FIG. 5 is displayed, the process monitors user inputs for BEGIN and END frames. When a BEGIN frame is entered, the sub-menu title and the address offset of the frame are sent to a buffer. When the END frame is entered, the address offset of the END frame are also sent to the buffer. The content of the buffer will then be sent to authoring system 135 where it is entered into an EA file shown in FIG. 6. After previewing the recording, the process ends (steps 724, 726, 728, 730 and 732).

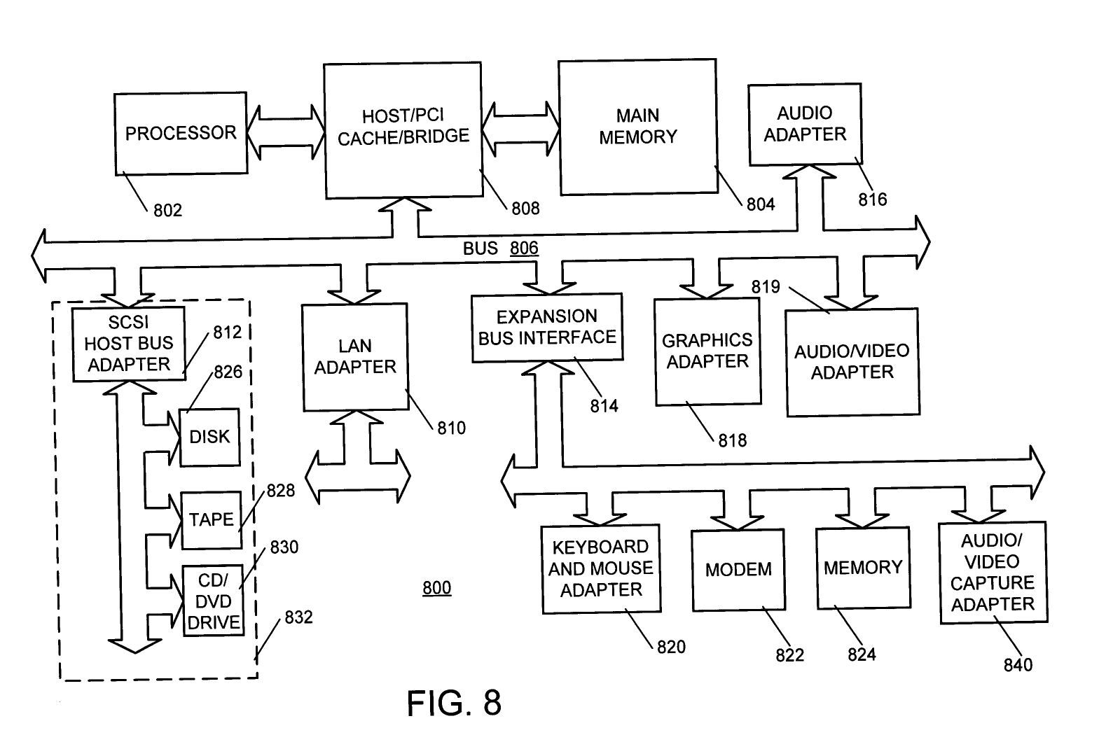

FIG. 8 is a block diagram illustrating a data processing system in which the representative mastering system 100 may be implemented. Data processing system 800 employs a peripheral component interconnect (PCI) local bus architecture. Although the depicted example employs a PCI bus, other bus architectures such as Accelerated Graphics Port (AGP) and Industry Standard Architecture (ISA) may be used. Processor 802 and main memory 804 are connected to PCI local bus 806 through PCI bridge 808. PCI bridge 808 also may include an integrated memory controller and cache memory for processor 802. Additional connections to PCI local bus 806 may be made through direct component interconnection or through add-in boards. In the depicted example, local area network (LAN) adapter 810, SCSI host bus adapter 812, and expansion bus interface 814 are connected to PCI local bus 806 by direct component connection. In contrast, audio adapter 816, graphics adapter 818, and audio/video adapter 819 are connected to PCI local bus 806 by add-in boards inserted into expansion slots. Expansion bus interface 814 provides a connection for a keyboard and mouse adapter 820, modem 822, additional memory 824 and an audio/video capture adapter 840. Small computer system interface (SCSI) host bus adapter 812 provides a connection for hard disk drive 826, tape drive 828, and CD/DVD-Drive 830. Typical PCI local bus implementations will support three or four PCI expansion slots or add-in connectors.

An operating system runs on processor 802 and is used to coordinate and provide control of various components within data processing system 800 in FIG. 8. The operating system may be a commercially available operating system, such as Windows XP, which is available from Microsoft Corporation. An object oriented programming system such as Java may run in conjunction with the operating system and provide calls to the operating system from Java programs or applications executing on data processing system 800. “Java” is a trademark of Sun Microsystems, Inc. Instructions for the operating system, the object-oriented operating system, and applications or programs are located on storage devices, such as hard disk drive 826, and may be loaded into main memory 804 for execution by processor 802.

Those of ordinary skill in the art will appreciate that the hardware in FIG. 8 may vary depending on the implementation. Other internal hardware or peripheral devices, such as flash ROM (or equivalent nonvolatile memory) or optical disk drives and the like, may be used in addition to or in place of the hardware depicted in FIG. 8. Also, the processes of the present invention may be applied to a multiprocessor data processing system.

The depicted example in FIG. 8 and above-described examples are not meant to imply architectural limitations. For example, data processing system 800 may also be a notebook computer or hand held computer. Data processing system 800 also may be a kiosk or a Web appliance.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method of authoring digitized audio/video recordings comprising the steps of:
previewing an audio/video data recording to identify scenes to be included in at least one version of the recording, a scene being a group of contiguous video frames;
identifying the scenes;
selecting a title by which to identify the at least one version of the recording; and
associating the identified scenes with the selected title.

2. The method of claim 1 wherein an encoding system is used to convert an analog audio/video recording into the digitized audio/video recording.

3. The method of claim 2 wherein the previewed recording, including the selected title, is recorded on a DVD.

4. The method of claim 2 wherein an emulator is used to preview the recording.

5. The method of claim 4 wherein associating the identified scenes with the selected title occurs in the emulator.

6. The method of claim 5 wherein associating the identified scenes with the selected title occurs in an authoring system.

7. A computer program product on a computer readable medium for authoring digitized audio/video recordings comprising:
code means for previewing a digitized audio/video recording to identify scenes to be included in at least one version of the recording, a scene being a group of contiguous video frames;
code means for identifying the scenes;
code means for selecting a title by which to identify the at least one version of the recording; and
code means for associating the identified scenes with the selected title.

8. The computer program product of claim 7 wherein an encoding system is used to convert an analog audio/video recording into the digitized audio/video recording.

9. The computer program product of claim 8 wherein the previewed recording, including the selected title, is recorded on a DVD.

10. The computer program product of claim 9 wherein an emulator is used to preview the recording.

11. The computer program product of claim 10 wherein associating the identified scenes with the selected title occurs in the emulator.

12. The computer program product of claim 10 wherein associating the identified scenes with the selected title occurs in an authoring system.

13. A system for authoring digitized audio/video recordings comprising:
at least one storage system for storing code data; and
at least one processor for processing the code data to preview a digitized audio/video data recording to identify scenes to be included in at least one version of the recording, a scene being a group of contiguous video frames, to identify the scenes, to select at least one title by which to identify the at least one version of the recording, and to associate the identified scenes with the selected title.

14. The system of claim 13 wherein an encoding system is used to convert an analog audio/video recording into the digitized audio/video recording.

15. The system of claim 14 wherein the previewed recording, including the selected title, is recorded on the DVD.

16. The system of claim 15 wherein an emulator is used to preview the recording.

17. The system of claim 16 wherein associating the identified scenes with the selected title occurs in the emulator.

18. The system of claim 17 wherein associating the identified scenes with the selected title occurs in an authoring system.
